(19) United States
(12) Patent Application Publication
(10) Pub. No.: US 2015/0178715 A1
(43) Pub. Date: Jun. 25, 2015

(54) AUTHENTICATING ENTITIES ENGAGING IN AUTOMATED OR ELECTRONIC TRANSACTIONS OR ACTIVITIES

(71) Applicant: Finsphere Corporation, Bellevue, WA (US)

(72) Inventors: Michael F. Buhrmann, North Bend, WA (US); Charles L. Dennis, Sammamish, WA (US); Jeffrey Brennan, Mill Creek, WA (US)

(21) Appl. No.: 14/639,396

(22) Filed: Mar. 5, 2015

Related U.S. Application Data
(63) Continuation of application No. 13/752,271, filed on Jan. 28, 2013.
(60) Provisional application No. 61/591,232, filed on Jan. 26, 2012.

(51) Int. Cl. G06Q 20/32; H04W 64/00; H04M 1/27

(52) U.S. Cl. CPC G06Q 20/3224; H04M 1/27; H04W 64/00

(57) ABSTRACT

An automated system and method for authenticating entities or individuals engaging in automated or electronic transactions or activities such as financial transactions, accessing computer applications, computer software, data networks or other automated or electronic devices requiring identity and/or reliability verification is provided.

### PRIORITY CLAIM AND CROSS REFERENCE TO RELATED APPLICATIONS

This application is a continuation of and incorporates by reference U.S. patent application Ser. No. 13/752,271 filed on Jan. 28, 2013, which claims the benefit of and incorporates by reference U.S. Provisional Appl. No. 61/591,232 filed Jan. 26, 2012. The following applications are likewise hereby incorporated by reference in their entireties as if fully set forth herein: U.S. patent application Ser. No. 11/933,803 filed on Nov. 1, 2007 which claims priority to U.S. Provisional Patent Application No. 60/895,144 filed on Mar. 16, 2007, U.S. Provisional Patent Application No. 60/909,718 filed on Apr. 3, 2007 and U.S. Provisional Patent Application No. 60/979,663 filed on Oct. 12, 2007. U.S. patent application Ser. No. 13/303,809 filed on Nov. 23, 2011 which is the US National Stage of Patent Cooperation Treaty Application No. PCT/US2010/044019 filed on Jul. 30, 2010 which claims priority to U.S. Provisional Patent Application No. 61/230,628 filed on Jul. 31, 2009. U.S. patent application Ser. No. 13/382,900 filed on Jan. 6, 2012 which is the US National Stage of Patent Cooperation Treaty Application No. PCT/US2010/041264 filed on Jul. 7, 2010 which claims priority to U.S. Provisional Patent Application No. 61/223,677 filed on Jul. 7, 2009 and U.S. Provisional Patent Application No. 61/223,671 filed on Jul. 7, 2009. U.S. patent application Ser. No. 13/303,809 filed on Nov. 23, 2011 which is a continuation of U.S. patent application Ser. No. 12/332,878 filed on Dec. 11, 2008 now U.S. Pat. No. 8,116,731 issued on Feb. 14, 2012 which claims priority to U.S. Provisional Patent Application No. 61/058,621 filed on Jun. 4, 2008 and U.S. Provisional Patent Application 61/027,892 filed Feb. 12, 2008. U.S. patent application Ser. No. 12/992,064 filed on Feb. 9, 2011 which is the US National Stage of Patent Cooperation Treaty Application No. PCT/US2009/003007 filed on May 13, 2009 which claims priority to U.S. Provisional Patent Application No. 61/053,152 filed on May 14, 2008. U.S. patent application Ser. No. 13/030,794 filed on Feb. 18, 2011 which claims priority to U.S. Provisional Patent Application No. 61/306,369 filed on Feb. 19, 2010. U.S. patent application Ser. No. 12/628,051 filed on Nov. 30, 2009 now U.S. Pat. No. 8,280,348 issued on Oct. 2, 2012 which claims priority to U.S. Provisional Patent Application No. 61/167,111 filed on Apr. 6, 2009.

### COPYRIGHT NOTICE

This disclosure is protected under United States and International Copyright Laws. © 2015 FINSPHERE, INC. All Rights Reserved. A portion of the disclosure of this patent document contains material which is subject to copyright protection. The copyright owner has no objection to the facsimile reproduction by anyone of the patent document or the patent disclosure after formal publication by the U.S. Patent Office, as it appears in the U.S. Patent and Trademark Office patent file or records, but otherwise reserves all copyright rights whatsoever.

### BACKGROUND OF THE INVENTION

In the following discussion, the terms “activity” and “transaction” are used for illustrative purposes. In general, activities relate to automated or electronic interactions with hardware devices or software programs, such as accessing computer systems or online web sites. Transactions relate to automated or electronic transactions, such as personal data transactions or financial transactions such as payments, fund-transfers, fund withdrawals, deposits, changes to account information, etc. Also, the term “entity” is used for illustrative purposes. In general, entities requiring authentication are individuals, data subjects or any electronic or computing devices that may require some form of identity authentication.

Accurate authentication of the identity of users or entities engaged in automated activities or transactions requiring security is a problem that continues to grow. Many solutions have been introduced to detect or prevent unauthorized access to secure hardware and software systems that attempt to determine through various means if an entity engaging in a transaction or accessing a computer or application is the lawful and rightful user. Identity theft has become more and more pervasive and does not only facilitate financial fraud. It may be perpetrated against any computer applications, systems and services that require security and where identity authentication is needed.

There are generally two recognized categories of identity theft that are perpetrated against legitimate users of automated or electronic transactions and activities. The first is known as “financial identity theft” and is typically based upon the use of another's identity to obtain goods and services. The second, known as “identity deception” is generally based upon the use of another's identity or identifying information to intentionally deceive others.

A classic example of financial identity theft, typically synonymous with bank fraud, occurs when an offender obtains a loan from a financial institution by impersonating someone else. The offender pretends to be the victim by presenting an accurate name, address, birth-date or other information the lender requires to establish identity. Even if this information is checked against data at a national credit-rating service, the lender encounters no concerns, as all of the victim's information matches the records. The lender has no easy way to discover that the person is pretending to be the victim, especially if an original, government-issued ID can't be verified, as is the case in online, mail, telephone and fax-based transactions. The offender keeps the money from the loan, the financial institution is never repaid and the victim is wrongly blamed for defaulting on a loan never truly authorized.

Another example of financial identity theft is when an offender obtains another's credit card or debit card account information, such as account number, account expiration date, card verification value or other data associated with an individual's credit card account. The offender then uses the information to create a counterfeit card or otherwise make purchases of goods and services at a point-of-sale, withdraw funds at an automatic teller machine or use the account information to make purchases over the telephone or via online web sites.

In most cases, financial identity theft is reported to a national consumer credit reporting agency or credit bureau as a collection or bad loan under the impersonated individual's record. The victim may discover the incident by being denied a loan, seeing the accounts, viewing their own financial transactions and history or by being contacted by creditors or collection agencies. The victim's credit score, which affects their ability to acquire new loans or credit lines, and rates on existing accounts may be adversely affected until they are able to successfully dispute the complaints and have them removed from their record. Other forms of financial fraud associated with identity theft include account takeovers, passing bad checks and “busting out” an account. A bust out is a sudden withdrawal of all available funds associated with deposit fraud. If withdrawals or checks are made against the impersonated individual's real accounts, that individual may need to convince the bank that the withdrawal was fraudulent or file a court case to retrieve lost funds. If checks are written against fraudulently opened checking accounts, the person receiving the checks will suffer the financial loss. However, the recipient of a check might attempt to retrieve money from the impersonated individual by using a collection agency. This activity would appear in the victim's credit history until the check was shown to be fraudulent.

Impersonating another's identity to deceive, for reasons other than financial gain, also has far-reaching consequences. Preventing identity deception has application to many circumstances where individual security is a primary concern. For example, the ability to authenticate the identity of an individual to prevent deception has application to law enforcement, public security, cyber crime and any online means where individuals have an expectation that existing security measures are adequate.

Identity deception occurs, for example, when an individual obtains someone else's electronic login information for access to a web-based online application such as a social networking web site. The individual successfully enters a username and password that belongs to the victim. Once accepted by the application, that individual has access to the victim's personal profile information and application features. Furthermore, the individual can establish and maintain communications with the victim's friends and family. The victim's personal profile information can be modified or deleted and other damage can be inflicted upon the victim for malicious purposes. Criminals, parolees and online predators can make use of the victim's identity for dangerous and deceptive purposes.

Credit card issuers and financial institutions, such as banks, attempt to limit financial identity theft and fraud losses by analyzing a variety of data and information associated with, for example, an automated credit card transaction. Rules-based “parameter analysis” is used along with pattern recognition and probabilistic techniques to determine the legitimacy of a card transaction. Parameter analysis techniques are used to examine, for example, the number of credit card transactions on a particular account within a specified period of time, say 24 hours, and the dollar amount of the transaction. If the number of transactions or the dollar amount exceed some pre-defined threshold, the transaction can be flagged as potentially fraudulent and further action can be taken. This action may be as drastic as denying the transaction and blocking the card holder's account. Parameter analysis, however, often times yields false-positive results, where the financial transaction is in fact legitimate, but falls outside the parameter thresholds set.

Probabilistic, or predictive, techniques include the use of statistical analysis and pattern recognition using many more parameters than are typically used in rules-based parameter analysis. Probabilistic techniques require the construction of behavioral models based on potentially hundreds of parameters to provide a probability that a particular financial transaction is fraudulent. These parameters typically include detailed data about multiple card holders, multiple merchants, multiple transactions and transaction histories that provide the ability to filter, screen and isolate those financial transactions which are likely to be fraudulent. Over time, this aggregated and detailed data about transactions are used to enhance the statistical model so patterns emerge. Thus, the statistical model is continually refined so that a particular transaction, when processed through the model, results in a more accurate determination of the likelihood of fraud.

Probabilistic techniques and models to determine incidents of identity theft may be made more beneficial if a fraud risk score representing an individual user's characteristics is developed, rather than statistical models based on pattern recognition from many users' transaction characteristics. That is, authenticating the identity of an entity engaged in an automated activity or transaction has utility above and beyond systems that determine the likelihood that a transaction itself is fraudulent. It is desirable, therefore, to have an automated system that uses discrete available data regarding the entity, including the entity's wireless device location data, home location data and other Identity Data to create a fraud risk score for the entity that may be accessed by a variety of applications that require identity authentication. By using this method, false-positive indications of fraudulent activity may be further reduced.

The primary identifying characteristic of a particular wireless device is the dialable mobile directory number (MDN). The MDN can be up to 15 digits long and is a unique number worldwide among all wireless devices, regardless of country or telecommunications network operator. The format of the MDN has been standardized as the E.164 International Public Telecommunication Number by the International Telecommunications Union, a standards making organization within the United Nations. Because the MDN is unique worldwide to an entity's or individual's mobile service subscription and wireless device, it can be considered an extension of the unique identity of that wireless device's user.

Much of the utility of using an entity's or individual's wireless device as an extension of the identity of the user is enabled by the physical security of wireless devices. Wireless devices are inherently secure due to the properties of digital cellular telecommunications. Digital cellular technology has replaced analog cellular technology worldwide and with this advancement came cellular authentication. Cellular authentication uses a cryptographic security protocol and public key infrastructure that is only made possible by digital communications technology. This cryptographic security protocol prevents a mobile directory number from being used by any wireless device other than the one for which it was originally programmed. The only way to re-use a mobile directory number with another device is by special secure provisioning performed within secure network platforms by the wireless network operator. When this secure provisioning occurs, the mobile directory number is securely and solely associated with the device for which it is used. In the case of GSM networks, the secure wireless device is the subscriber identity module, or SIM card, which is associated with an individual and unique mobile service subscription. This is why a SIM card can be used in any GSM-based mobile phone without notifying the wireless network operator. In the case of CDMA networks, the wireless device is the mobile phone itself as SIM cards are not commercially supported.

### BRIEF DESCRIPTION OF THE DRAWING

FIG. 1 depicts the functional entities and modules of an exemplary Identity Register used to calculate and provide a fraud risk score for an identity authentication application. Included in the example is an Event Processing Module, a Wireless Device Location Module, a Wireless Device ID Database, an optional Identity Database, one or more Identity Risk Logic Resources and Identity Risk Configuration data in accordance with the principles of the present invention.

FIG. 2 depicts the functional entities and modules of an exemplary Identity Register used by an entity or individual to register and otherwise maintain Identity Data stored in the Identity Register.

FIG. 3 depicts an exemplary Wireless Device ID Database used to associate unique Wireless Device IDs with derived wireless device locations, identity authentication applications and fraud risk scores.

FIG. 4 depicts an exemplary Identity Database used to store unique Wireless Device IDs associated with other Identity Data associated with an entity or individual.

FIG. 5 depicts exemplary Identity Risk Configuration data used by, or associated with, one or more Identity Risk Logic Resources.

FIG. 6 depicts an exemplary information flow diagram of the Identity Register.

FIG. 7 depicts an exemplary process flow diagram of the Identity Register.

FIG. 8 depicts exemplary data sources according to an embodiment.

FIG. 9 depicts functional entities and modules according to an embodiment.

FIG. 10 depicts a process according to an embodiment.

FIG. 11 depicts location-based precision analytics according to an embodiment.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

An embodiment of the invention includes or may otherwise be implemented in an identity security services (ISS) platform that includes at least one Identity Register, which may be or include a Mobile Identity Register. In the ISS platform, the Mobile Identity Register is the database of record for uniquely identifying subscribers. When a user opts into one or more ISS services, a user profile is created in the Mobile Identity Register. The Mobile Identity Register user profile can then be used to correlate authentication events processed by multiple ISS services submitted by a broad array of customers, consumers and enterprises. In other words, the Mobile Identity Register enables visibility into a broad set of mobile subscriber's activities, thus increasing the performance of any single authentication solution.

In accordance with an embodiment of the present invention, there is provided an automated system and method for detecting identity theft, which uses one or more Identity Risk Logic Resources to evaluate wireless device users based on parameters about the wireless device and its user. These parameters enable the system to estimate a probability that an entity engaged in a particular automated transaction or activity is not, in fact, the entity authorized to do so. The probability is distinguished as a fraud risk score that may be provided as output to other automated systems or to a human decision-maker involved in determining the validity of an entity or individual engaged in an automated transaction or activity. The fraud risk score associated with an entity may be revised based on subsequent transactions or activities engaged in by the entity (i.e. the wireless device user) to designate a more accurate value that may be used for a variety of applications.

In one embodiment of the present invention, an entity's wireless device is representative of the entity's true identity. The use of the wireless device for identity authentication is a robust way of ensuring the true identity of entities accessing a computer application or system. Based on pervasive use of cell phone technology worldwide, it is surmised that an entity's or individual's unique mobile device associated with a unique mobile directory number (MDN) is a reasonable proxy for the identity and current location of the wireless device's owner. In this way, a wireless device can become a strong mechanism for fighting fraud and identity theft that may be perpetrated against the user, computer applications or electronic transactions. This is due to the fact that an individual's mobile phone is almost always on and with the individual, and the location of the mobile phone is derived from the Wireless Network or from some local wireless or wireline connection to some other automated system.

In one embodiment, an entity's or individual's wireless device is active, powered on and communicates with a Wireless Network, local wireless communications link or local wired communications link. The wireless device is in close proximity to a computer application network, system or device. Depending on the particular application, network, system or device, close proximity can be anywhere from several miles to several feet. The entity's or individual's wireless device MDN is provided and stored in an Identity Register. An identity authentication application or system is associated with and uses the functions and processes of the Identity Register. When the entity or individual comes into some proximity (as previously defined) of a computer application, network or device, or otherwise attempts to invoke a computer application, network or device, either himself or via some external communications mechanism, that requires identity authentication for access and operation, the Identity Register records and stores this invocation event. An identity authentication application supported by the Identity Register attempts to authenticate the user for that computer application, network or device. The Identity Risk Logic Resources used may be provided by the Identity Register or by an external computer application itself These logic resources are typically defined by distance and time parameters along with past identity authentication events that may also be based on distance and time or other means of authentication. The use of or actual respective logic resources, processes and computer applications used and pertaining to the identity authentication invocation events involved are recorded and stored at the Identity Register. The result, in the form of a fraud risk score, of the identity authentication application process are also stored. The continuing storage of identity authentication invocation events, processes, functions, logic resources and results associated with a particular and previously registered entity or individual may be used for analysis of subsequent identity authentication invocation events and processes. This analysis may be used to revise and refine a fraud risk score used to allow or deny access or operation of a computer application, activity, network, system or device for current or subsequent access or operation of said computer application, activity, network, system or device.

One embodiment of the present invention comprises identity authentication of an entity or individual wireless device user engaged in a secure automated transaction or activity based on the location of the user's wireless device. A Wireless Device Location Module is used to obtain the location of the wireless device from a macro Wireless Network, such as a cellular network or WiMAX network. The unique and identifying mobile directory number (MDN) has been initially registered, provided and stored in an external database or within the Identity Register that maintains Identity Data in a Wireless Device Identity (ID) Database and associated processing system. The Identity Register acts as the supporting system and database of record for identity authentication by receiving, detecting, recording, processing and storing identity Event Data or other data that lead to an identity authentication application or process. The Wireless Device ID Database records events based on user interaction, directly or indirectly, with the Identity Register system. Electronic triggers may originate from application events based on stored Identity Data or the proximity of a wireless device supporting automated and unsolicited communications with the system. The Wireless Device ID Database is used to maintain a fraud risk score for each entity or individual and unique Wireless Device ID. This value is initially generated by one or more Identity Risk Logic Resources and may be updated and revised based on subsequent events associated with the Wireless Device ID. As a non-limiting example, these events may be in the form of a local wireless communication with the system (such as a wireless device-based Bluetooth or WiFi connection to a computer), a local wired connection (such as a USB or FireWire® connection to a computer), the internet protocol (IP) address location of a computer user sending an email, a log-in function for a web site, a financial transaction event trigger such as the use of a credit card at an automatic teller machine or point-of-sale location, and the like. Over a given period of time, a user associated with a wireless device may trigger events that are associated with, connected to and recorded within the Identity Register. These events may cause the fraud risk score to be updated and revised for the particular wireless device and may be reported to another entity wishing to determine at some point in time what the fraud risk score is. Furthermore, the fraud risk score may be used to subsequently take some action for a particular transaction or activity associated with a wireless device user such as determining whether an activity or transaction engaged in by the wireless device user is likely fraudulent or not.

The wireless device user's Identity Data may be initially registered and created in a variety of ways, both directly and indirectly. One preferred embodiment of direct registration occurs when an individual enters identity information into a form on a web page presented by a registration application supported by the Identity Register. Identity information may contain a username, password, given name, address, sex, age, email address or various other information and the required and unique mobile directory number (MDN) associated with the user's wireless device. When this information is submitted, it may be confirmed by a variety of mechanisms. For example, a confirmation email may be sent to the provided email address containing an embedded secure link or uniform resource locator (URL) address. When the user clicks on this link, a web page may be presented by the initial registration application confirming the user's registration with the Identity Register. After the user's initial registration is confirmed, the user's Identity Data is stored in the Identity Register for use with a multiplicity of applications that may support the fraud risk score required for identity authentication related to transactions, computer applications, networks, systems or devices.

One preferred embodiment of indirect registration occurs when an event external to the Identity Register occurs and the Event Data as well as Identity Data is sent to the Identity Register. If no data or record within the Identity Register exists, a new record is created automatically based on the Wireless Device ID associated with the Event Data or Identity Data. The record may contain any and all data received and based on the external event. The received Identity Data is stored in the Identity Register for use with a multiplicity of applications that may support the fraud risk score required for identity authentication related to transactions, computer applications, networks, systems or devices.

Once an entity's or individual's Wireless Device ID is registered in the Identity Register, external application events requiring identity authentication may be detected, received, processed, recorded and stored by the Identity Register. As these events are recorded and stored, the Identity Register may support authentication applications using both current Event Data as well as aggregate or historical Event Data stored for a particular Wireless Device ID. All data stored for a particular Wireless Device ID in the Identity Register, new received Event Data, additional received external Identity Data, as well as the existing fraud risk score may be used to generate a new or current fraud risk score. The new value may be used to assist in a determination of identity authentication for a current authentication event or future authentication events. The calculated fraud risk score may be continually maintained, updated and revised based on events to assist in determining an authentication result for a given secure activity requiring identity authentication of the user.

An identification authentication process may be performed by, for example, an external authentication application that resides on a computing platform or device that communicates with the Identity Register system. The Identity Register system is comprised primarily of an Event Processing Module, a Wireless Device Location Module, a Wireless Device ID Database, an Identity Database and one or more Identity Risk Logic Resources.

An Event Processing Module enables communications, transmission and reception of data associated with the functions of the Identity Register and supports the basic communications with external applications to receive Identity Authentication Events and related data.

A Wireless Device Location Module enables communications with a Wireless Network to obtain the position or location of an entity's or individual's wireless device. Alternatively, the location of the wireless device may be obtained from the wireless device itself through GPS or other related systems.

A Wireless Device Identity (ID) Database enables the association of a unique wireless device identifier with the calculated fraud risk score, the wireless device location, a multiplicity of identity authentication applications, Identity Authentication Events and event locations and times associated with identity authentication applications.

An optional Identity Database enables the storage and use of additional Identity Data that may be obtained via an external system or application associated with the Identity Register. The Identity Database enables the association of a Wireless Device ID and one or more additional identity information elements associated with a unique Wireless Device ID such as an entity's or individual's home address, work address, related locations or addresses frequented by the individual, various telephone numbers associated with an individual and additional Wireless Device IDs related to the present Wireless Device ID. Additional Wireless Device IDs associated with, or otherwise related to, the present Wireless Device ID may be required, such as those that may be associated with family members that may be associated with the same identity authentication application.

The Identity Risk Logic Resources comprise one or more computer logic resources to calculate a fraud risk score based upon data obtained via the Event Processing Module, the Wireless Device ID Database, the Identity Database and Identity Risk Configuration data. Furthermore, Identity Risk Configuration data are used to configure or otherwise provide dynamic or static parameter values used by one or more Identity Risk Logic Resources.

Based upon current data regarding an identification authentication event, which may include the Wireless Device ID, Event Data, such as type of event, location of the event, time of the event and the particular application the event pertains to, as well as currently obtained or stored identity data associated with the Wireless Device ID, a fraud risk score is calculated representing the probability of risk that identity theft has occurred or may be occurring.

The fraud risk score is calculated using one or more appropriate Identity Risk Logic Resources that use the data pertaining to the current Identity Authentication Event and application. The logic resources consider a multiplicity of factors based on the received identity authentication Event Data as well as received or currently stored Identity Data. These logic resource factors comprise calculations pertaining to the current and known locations derived from the data including distances among the received and known locations as well as time variances among the received and known locations, i.e. when the individual was at the locations.

There are a multiplicity of location types about the entity or individual factored into the Identity Risk Logic Resources. “Transient” locations are considered to be those locations where the individual is at for potentially only brief periods of time, such as the locations derived from a Wireless Network based on the Wireless Device ID while an individual is mobile. Other transient locations may include locations where financial transactions occur, such as automatic teller machines or point-of-sale locations where an automated purchase is made using, for example, a credit card or debit card. Still other transient locations may include an automatic detection of the presence of an individual's wireless device at a particular location, such as passing through an airport metal detector, entering a secure building using wireless radio frequency identification (RFID) based on proximity cards or similar devices or entering a secure or alarmed home or office where a manual keypad is used by the individual to enter a personal identification number (PIN) to gain entry.

Other location types may be categorized as “semi-permanent” meaning that the locations may be somewhat transient, yet the individual spends more than brief periods of time there. Examples of semi-permanent locations may be work addresses where an individual may spend extended periods of time, but not most of the day, or vacation home addresses where an individual may spend extended periods of time at irregular time intervals, such as different seasons, months or weeks.

Still other location types may be categorized as “permanent” meaning that the locations where an individual frequents are somewhat static, such as the individual's home address. It may be assumed in the case of permanent locations that the individual spends more time at those locations than semi-permanent or transient locations.

Other location data may be derived from other Identity Data pertaining to the entity or individual, such as telephone numbers. Telephone numbers are geographically-based so they imply a form of location data. All dialable telephone numbers, wireline or wireless, are of the aforementioned form of the mobile directory number (MDN). They can be up to 15 digits long and are unique numbers worldwide among all telephones, regardless of country or telecommunications network operator. The format of the telephone number has been standardized as the E.164 International Public Telecommunication Number by the International Telecommunications Union, a standards making organization within the United Nations. All telephone number addresses are comprised of two distinct parts or sections: a Country Code (CC) and a National Significant Number (NSN). The NSN may be comprised of two portions: a National Destination Code (NDC) and a Subscriber Number (SN). If the telephone number is a wireline number, the values for CC, NSN or NDC may be representative of the physical geography of where the landline central office telephone switch serving that line number resides. If the telephone number is a wireless number or mobile directory number (MDN), the values for CC, NSN or NDC may be representative of the physical geography of where the mobile subscriber's home mobile switching center (MSC) resides. Using a multiplicity of telephone numbers associated with an entity or individual, such as one or more home telephone numbers, work telephone numbers and mobile telephone numbers, transient, semi-permanent and permanent location types may be derived and used by the present invention.

One or more Identity Risk Logic Resources may consider one or more of these location types along with the distance variances among them. Also, if the dates and times are known when individuals are at these locations, the time variances among the multiple locations where an entity or individual has been may be factored into the logic resources.

The transient Identity Authentication Event, location and time parameters derived from currently received or stored location data may be stored in the Wireless Device ID Database. The semi-permanent and permanent location parameters may be stored in the Identity Database. These parameters may be given a particular and relative “weighting factor” to distinguish their relative importance for use in the Identity Risk Logic Resources.

These weighting factors may be stored for use by the Identity Risk Logic Resources in an Identity Risk Configuration file. This configuration file may be dynamically modified for use with a multiplicity of applications requiring identity authentication. The relative weighting factors may be given values that represent the importance of the parameters for use by the logic resources. As an illustrative example, a transient wireless device location associated with a Wireless Device ID currently obtained from a Wireless Network may have a larger relative value in a risk calculation than the individual's home address associated with the Wireless Device ID. If a particular application, such as a credit card cash advance financial transaction requires a fraud risk score to determine if the transaction is fraudulent or not, and the wireless device location is quite far from the individual's semi-permanent or permanent stored home and work addresses, a higher weighting factor for the transient wireless device location may result in a high fraud risk score implying a higher risk of identity theft that might be perpetrated upon the entity or individual. Furthermore, if the wireless device location of the entity or individual is determined to be quite far from the automated transaction location, the relative weighting factors of the locations may also result in a high fraud risk score indicating a higher risk of identity theft. This fraud risk score may be returned to some external Results Processing System and stored in the Wireless Device ID Database and subsequently used by a multiplicity of identity authentication applications. If the fraud risk score is returned to a Results Processing System, an authentication application accessing the Results Processing System may use the fraud risk score to take some action or apply some treatment to the entity's or individual's automated activity or transaction.

Over time and for a variety of identity authentication applications, the entity's or individual's fraud risk score may be modified, revised or otherwise refined based on the types of authentication applications, types of application events, locations of the events, times of the events, location of the entity's or individual's wireless device and other known identity parameters stored within the Identity Register.

Data within the Identity Register to generate a fraud risk score may be created and stored dynamically based on the reception of Event Data or Identity Data associated with an identity authentication application. The creation of a new Wireless Device ID record within the Wireless Device ID Database may be dynamically created for an initial Identity Authentication Event for a particular identity authentication application. Furthermore, Identity Data may be provided to, or registered with, the Identity Register by individuals themselves who may wish to subscribe to some identity theft protection service.

As an illustrative example, individuals may access an Internet-based application displaying a web page containing a form that enables them to register their Wireless Device IDs and other Identity Data that may be used by a multiplicity of identity authentication applications. This exemplary Identity Register application may enable individuals to add, modify or delete their own Identity Data over time as that data changes enabling them to participate in their own identity theft protection.

A particular identity authentication application may reside within or be external to the Identity Register. The communication mechanism to receive Event Data and Identity Data may be via a data communications network or more directly if the identity authentication application resides within the same platform as the Identity Register.

Supported identity authentication applications are used to determine the authenticity of a user attempting to access or otherwise operate a computer application, network or device. These identity authentication applications may also represent the Results Processing System receiving the fraud risk score for a particular Identity Authentication Event.

Illustrative examples of Identity Authentication Events pertaining to identity authentication applications may include a wireless device user coming into proximity of an electronic or automated device associated with a secure computer application or network that may detect the wireless device via a wireless protocol such as Bluetooth, WiFi, RFID, near field communications (NFC), electro-magnetic or other communications protocol or mechanism. Other illustrative examples of Identity Authentication Events may include physical connectivity of an electronic or automated device such as a wireless device, biometric device, magnetic card, network connected computerized device or other connected communications protocol or mechanism to a secure computer application, network or device requiring authentication for access or to authenticate a secure activity or transaction. Physical connectivity enabling communication of Identity Authentication Events may be via a USB wired connection, serial port connection, electro-magnetic or other communications protocol or mechanism. Other illustrative examples may include invocation of some identity authentication application requiring an authentication process for access or operation such as some manual action taken by an individual accessing a computerized, electronic or automated device, including pressing a “hard” or “soft” button on a computerized system or device, accessing a biometric device or employing some mechanical action. Still other illustrative examples may include some automatic invocation of an authentication process with no manual user interaction by a computerized, electronic or automated device, including a wireless device, biometric device, electronic message or telecommunications call.

Illustrative examples of the types of activities and transactions that the present invention may provide identity theft protection and utility include financial transactions such as credit card transactions, debit card transactions, electronic fund transfers, deposit transactions and non-financial bank transactions such as change of account data transactions. Other examples include online account activations, online purchases, online banking transactions, online gaming access, online sharing of data, online interactive messaging systems (e.g. sending and receipt of email, instant messages, etc.), online social networking, online communications systems, software-based automated systems and services, hardware-based automated systems and services, computer access (e.g. log-ons, log-offs, etc.), website registrations, activations, deactivations, computer applications, network or device registrations, activations, deactivations and any applications requiring identity authentication.

In one embodiment of the present invention, an Identity Register is provided. The Identity Register enables the location of a wireless device obtained from a Wireless Network to be used in conjunction with Identity Data and Event Data emanating from an Identity Authentication Event associated with an application requiring identity authentication to generate a fraud risk score representing the likelihood that identity theft has occurred.

In one embodiment, an Event Processing Module of the present invention receives current Event Data, an entity's or individual's Identity Data and an entity's or individual's wireless device location data in a multiplicity of formats. In this embodiment, the Event Processing Module passes the Event Data to the Wireless Device ID Database. Similarly, the Event Processing Module passes the Identity Data to the Identity Database. A Wireless Device Location Module obtains the location of the wireless device associated with the Event Data and Identity Data and identified by a unique Wireless Device ID. The Wireless Device Location Module passes, directly or indirectly, the wireless device location to the Wireless Device ID Database for storage. The Event Data, Identity Data and wireless device location data are passed to one or more Identity Risk Logic Resources. This logic results in the generation of a fraud risk score. The Identity Risk Logic Resources obtain data from an Identity Risk Configuration file that provides information pertaining to how the Event Data and Identity Data for a particular identity authentication application are to be calculated. The resulting and generated fraud risk score can then be passed to a Results Processing System associated with the identity authentication application. The identity authentication application may then take some action based on the generated and received fraud risk score. The fraud risk score is stored in the Wireless Device ID Database for subsequent use by other identity authentication applications as well as to be used in subsequent identity risk logic calculations. The fraud risk score may be provided in a multiplicity of formats and used to authenticate, verify or validate an entity's or individual's identity associated with an automated activity or transaction engaged in by the entity or individual.

In an exemplary operation of the Identity Register, an Identity Authentication Event is generated from some automated or manual activity engaged in by an entity or individual. In one embodiment, an entity's or individual's wireless device is active, powered on and communicates with a Wireless Network, local wireless communications link or local wired communications link. The wireless device is in close proximity to a computer application network, system or device. Depending on the particular application, network, system or device, close proximity can be anywhere from several miles to several feet.

When the individual comes into some proximity (as previously defined) of a computer application, network or device, or otherwise attempts to invoke a computer application, network or device, either himself or via some external communications mechanism, that requires identity authentication for access and operation, an authentication application passes information about that event as Event Data to the Event Processing Module of the Identity Register. The Event Data may contain, in a multiplicity of formats, various information such as the unique Wireless Device ID of an entity, individual or data subject associated with the event, the type of event, the particular authentication application the event pertains to, the location where the event occurs and the date and time of the event. Non-limiting examples of the types of events that may occur are registration events where an entity or individual is either directly or indirectly registering with the Identity Register platform. A direct registration event may occur, for example, via an application that supports or otherwise enables registration of data directly by an individual into the Identity Register. An indirect registration event may be, for example, via an application that supports or otherwise enables registration of data indirectly, or on behalf of, an entity or individual into the Identity Register. A registration event may include the Wireless Device ID of the entity or individual in the form of a unique mobile directory number (MDN) or other type or format of unique identifier. When a registration event occurs, the unique wireless identifier representing the entity's or individual's identity is included in the event. Examples of other events are authentication events where an identity authentication process is requested to be performed within the Identity Register. For authentication events, if an entity or individual is not previously registered within the Identity Register, they may be indirectly registered as a function of the authentication event. When an authentication event occurs, the unique Wireless Device ID representing the entity's or individual's identity is included in the event. This Wireless Device ID may be used to register the entity or individual within the Identity Register. An authentication event, for example, may be an event that represents a request for the Identity Register to generate a fraud risk score for the entity or individual represented by the unique Wireless Device ID, or other identifier. Other events may include requests for one or more fraud risk scores stored within the Identity Register that may or may not be associated with a particular authentication event.

Non-limiting examples of authentication applications that may produce authentication events represented by Event Data include financial transactions such as automated fund withdrawal transactions using an automatic teller machine or point-of-sale terminal, fund transfer transactions, deposit transactions and non-monetary transactions such as changes to financial account information. For these transactions, the unique Wireless Device ID along with an application identifier may be sent as Event Data to the Identity Register in order to perform an identity authentication process for the individual associated with the unique Wireless Device ID. Other examples of authentication applications that may produce authentication events may be applications that enable access to online websites, applications that enable access to computer hardware systems, applications that enable entry into homes or buildings such as an individual entering a digital code into a keypad or applications where a wireless device may come into proximity of another hardware device that supports RFID or NFC communications or other wireless communications protocol.

Non-limiting examples of the location information of where an event occurs that may be associated and included with Event Data include a multiplicity of information element formats that represent geographic location data such as a physical geographic address (e.g. street number, street name, city, state, province, country, postal code, ZIP code, etc.), a physical data communications address (e.g. an Internet Protocol geographic address of the form) XX.XX.XX.XX) a logical or virtual place or data communications address (e.g. a post office box or a uniform resource locator or URL address), some representation of an address (e.g. an alias name or label identifying an address), a geographic place name (e.g. “Central Park”), mapping coordinates (e.g. latitude and longitude or other projection coordinates) or a mapping identifier in some customized format.

The date and time that an Identity Authentication Event occurs may also be included in the Event Data to be passed to the Identity Register. The date and time may be generated external to the Identity Register and associated with an application external to the Identity Register and passed as Event Data. The date and time may be generated by the Identity Register itself when Event Data is received by the Event Processing Module. Event Data passed to the Identity Register may be subsequently used to generate fraud risk scores for entities, individuals or data subjects associated with the Event Data.

In an exemplary operation of the Identity Register, Identity Data pertaining to an entity or individual may be sent to the Identity Register. This Identity Data may include, in a multiplicity of formats, various information related to the identity of the entity or individual, or data subject, either previously registered within or to be registered within the Identity Register. The Identity Data may contain in a multiplicity of formats various information such as the unique Wireless Device ID of an entity or individual or data subject associated with the Identity Data. Non-limiting examples of Identity Data may include both location-based data as well as other data. Location-based data may include the individual's Wireless Device ID (e.g. MDN), home address, work address, other addresses frequented by the individual, home telephone number, work telephone number, other telephone numbers used, or any other location related data. Data that may be included that is not location-based may include the individual's gender, birth date, mother's maiden name or other identity data associated with the individual.

Identity Data may be sent to the Identity Register either directly or indirectly when an entity or individual is registering with the Identity Register or during an Identity Authentication Event. The Identity Data may be included as a portion of the Event Data sent to the Identity Register or may be sent separately to the Identity Register via an identity registration application external to the Identity Register or otherwise provided by, supported by or enabled by the Identity Register. Identity Data passed to the Identity Register may be subsequently used to generate fraud risk scores for entities, individuals or data subjects associated with the Identity Data.

Once Event Data, and optionally Identity Data, are received by the exemplary Event Processing Module within the Identity Register pertaining to an entity, individual or data subject and associated with an Identity Authentication Event, the Event Data is passed to the Wireless Device ID Database for storage. Identity Data is passed to the Identity Database for storage. Based on the type of event, a fraud risk score may be generated within the Identity Register. When a fraud risk score is required to be generated, the Event Processing Module passes the unique Wireless Device ID associated with the Event Data to the exemplary Wireless Device Location Module.

The unique Wireless Device ID is typically the dialable Mobile Directory Number (MDN) of the user's wireless device, but may assume other values as appropriate, such as an Electronic Serial Number (ESN) of the device, an International Mobile Subscriber Identity (IMSI) or an International Mobile Equipment Identity (IMEI). Use of the MDN is typical due to global uniqueness among wireless device users and its common use in wireless industry network communications protocols. The MDN of the wireless device may be used to query the Wireless Network via the Wireless Device Location Module for current or last known location information of the wireless device, or location information pertaining to the wireless device may be obtained autonomously by the Wireless Device Location Module from the Wireless Network. Location information may be requested by these modules or the location information may be obtained autonomously.

Once the wireless device location is obtained by the Identity Register, this location information is passed along with the associated and corresponding Wireless Device ID to the Wireless Device ID Database within the Identity Register to resolve the location information into an appropriate format for adequate use by the Identity Risk Logic Resources. The exemplary Wireless Device ID Database is employed, to resolve the obtained location information into appropriate geographic mapping information to be used for a particular identity risk logic calculation. The resulting geographic location value derived from the database and associated with the unique Wireless Device ID previously obtained are sent to the Identity Risk Logic Resources.

Similarly, once the event location is obtained by the Identity Register, this location information is passed along with the associated and corresponding Wireless Device ID to the Wireless Device ID Database within the Identity Register to resolve the location information into an appropriate format for adequate use by the Identity Risk Logic Resources. The exemplary Wireless Device ID Database is employed, to resolve the obtained location information into appropriate geographic mapping information to be used for a particular identity risk logic calculation. The resulting geographic location value derived from the database and associated with the unique Wireless Device ID previously obtained are sent to the Identity Risk Logic Resources.

Once Event Data is obtained for an Identity Authentication Event emanating from an identity authentication application, the Event Data may invoke the Identity Register to generate a fraud risk score. A fraud risk score pertaining to an entity, individual or data subject and associated with an Identity Authentication Event is generated by one or more Identity Risk Logic Resources using data obtained from the Event Data, optional Identity Data, data obtained from the exemplary Wireless Device ID Database, data obtained from the exemplary Identity Database, and data from the exemplary Identity Risk Configuration. The Identity Risk Logic Resources use a variety of data from these sources in a multiplicity of formats and applies the information provided by the Identity Risk Configuration in order to proceed with the appropriate identity risk logic calculation to produce the particular fraud risk score.

The Identity Risk Logic Resources use location data obtained about the authentication event for an authentication application engaged in by the entity or individual, the entity's or individual's wireless device location data, location data associated with the Wireless Device ID stored in the exemplary Identity Database, one or more previously calculated fraud risk scores stored in the exemplary Wireless Device ID Database and weighting factors designating the importance of each of the information elements that may be defined in the Identity Risk Configuration data to generate a current fraud risk score for the entity, individual or data subject. The Identity Risk Logic Resources may generate a multiplicity of distance and time variables from the data for the fraud risk score calculation such as the distance between the entity's or individual's wireless device location and the individual's home location, the distance between the individual's wireless device location and the individual's work location, the distance between the individual's home location and the individual's work location, the distance between the individual's wireless device location and the Identity Authentication Event location, the distance between the entity's or individual's home location and the Identity Authentication Event location, the distance between the individual's work location and the Identity Authentication Event location, the distance between other frequented locations stored in the Identity Database and the Identity Authentication Event location, the distance between other frequented locations stored in the Identity Database and the individual's wireless device location, etc. Similarly, the time variance between the last known wireless device location and the Identity Authentication Event location as well as other time variances among the data parameters may be used in the identity risk logic calculation.

Once a fraud risk score representing the likelihood that identity theft has occurred, or is occurring, for the particular Identity Authentication Event, it may be passed in an appropriate format to a Results Processing System. The Results Processing system may be external to the Identity Register or internal to the Identity Register. The Results Processing System may reside within, or be the same as, the aforementioned authentication application or some other system that requires the fraud risk score results. An exemplary Results Processing System may apply the fraud risk score to any type of application regardless of the value of the result or the type of application. These applications may include identity authentication systems, activity fraud management systems, financial fraud detection systems, online website applications or any secure system where identity authentication is required.

Note that an embodiment of the present invention is not limited to wireless devices used as mobile telephones and identified by an MDN. The present invention may apply for use with any wireless device distinguished by a unique identifier.

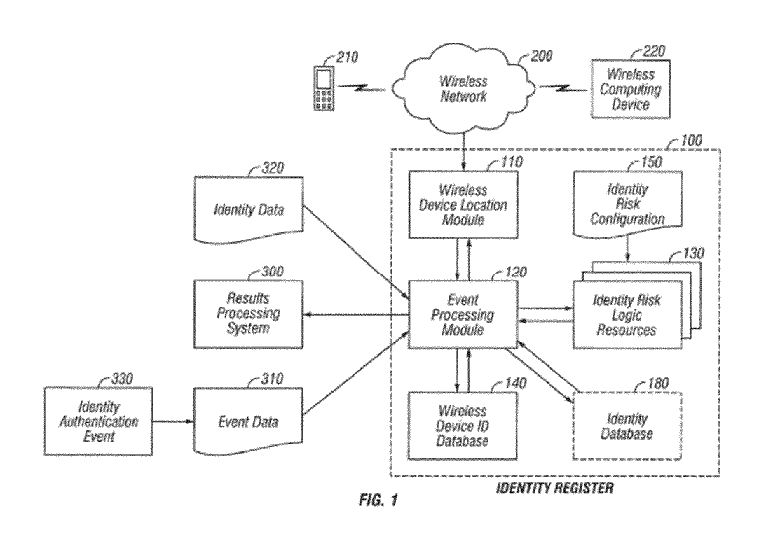

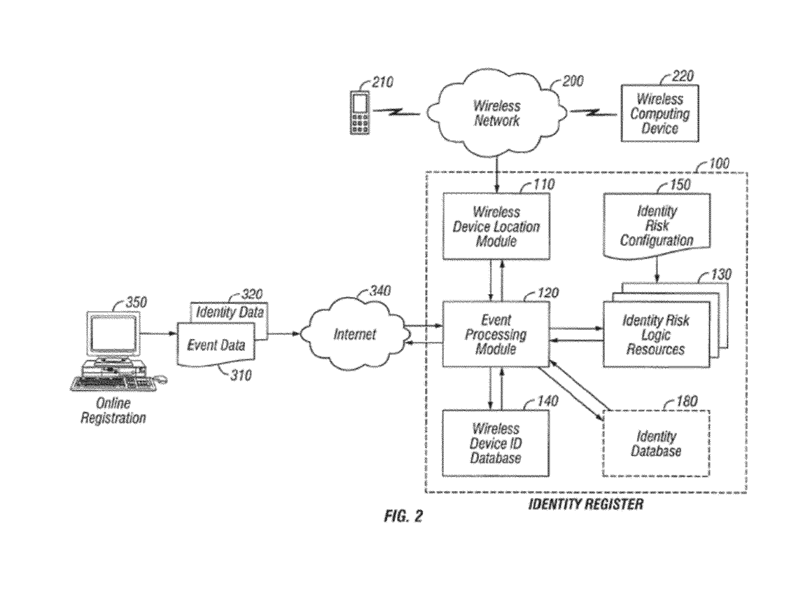

In FIG. 1, one embodiment of an Identity Register 100 of an embodiment of the present invention includes an Event Processing Module 120, a Wireless Device Location Module 110, a Wireless Device ID Database 140, an optional Identity Database 180, Identity Risk Logic Resources 130, and an Identity Risk Configuration 150, in accordance with the principles of the present invention. The Event Processing Module 120 obtains Event Data 310 emanating from some Identity Authentication Event 330 associated with some identity authentication application.

The Event Processing Module 120 also obtains Identity Data 320 associated with an entity, individual or data subject as part of a registration process or associated with Event Data 310. The Event Processing Module 120 passes the Event Data 310 to the Wireless Device ID Database 140 for storage and use for the generation of a fraud risk score based upon the provided Wireless Device ID included with the Event Data 310.

The Event Processing Module 120 passes the Identity Data 320 to the optional Identity Database 180 for storage and use for the generation of a fraud risk score based upon the provided Wireless Device ID included with the Identity Data 320. The Event Processing Module 120 passes the entity's or individual's unique Wireless Device ID associated with both the Event Data 310 and the Identity Data 320 to the Wireless Device Location Module 110 that is used to obtain the location of a Wireless Device 210, such as a mobile telephone, from a Wireless Network 200.

The Wireless Device Location Module 110 may also obtain wireless device location information from any type of Wireless Computing Device or appliance 220 for which an identity authentication application may apply. The Wireless Device Location Module 110 passes the obtained wireless device location associated with the Wireless Device ID to the Wireless Device ID Database 140 directly or indirectly via the Event Processing Module 120. The Event Processing Module 120, the Wireless Device ID Database 140 and the optional Identity Database 180 provide the appropriate data and parameters associated with the Wireless Device ID to the Identity Risk Logic Resources 130 to generate a fraud risk score. The data may be provided directly to one or more Identity Risk Logic Resources 130 by the respective databases, 140 and 180, or via the Event Processing Module 110. One or more Identity Risk Logic Resources 130 may use configuration data supplied by the Identity Risk Configuration 150 to properly calculate and generate a fraud risk score. Once the fraud risk score is calculated, it is sent to a Results Processing System 300 directly or indirectly via the Event Processing Module 120. The Results Processing System 300 may then apply fraud risk score to some identity authentication application associated with an Identity Authentication Event 330 engaged in by an entity, individual or data subject associated with a Wireless Device 210 or other Wireless Computing Device 220.

FIG. 2 depicts the use of one embodiment of an Identity Register 100 by an exemplary Online Registration application 350. One embodiment of an Online Registration application 350 may be an Internet-based web application accessed via a computer that enables an individual to enter Identity Data 320 into a web-based form and send Identity Data 320 and registration Event Data 310 to the Identity Register 100 via the Internet 340. The Event Processing Module 120 obtains the entity's or individual's registration Event Data 310 as well as the Identity Data 320 emanating from the Online Registration application 350 supplied by an entity or individual and based upon the Wireless Device ID provided with the Identity Data 320. In an embodiment, the computer alluded to above may be the Wireless Device 210 itself, with registration achieved either through a mobile application on Device 210 or through the user registering through the internet on Device 210. The Event Processing Module 120 passes the registration Event Data 310 to the Wireless Device ID Database 140 for storage and use for the generation of a fraud risk score. The Event Processing Module 120 passes the Identity Data 320 to the optional Identity Database 180 for storage and use for the generation of a fraud risk score.

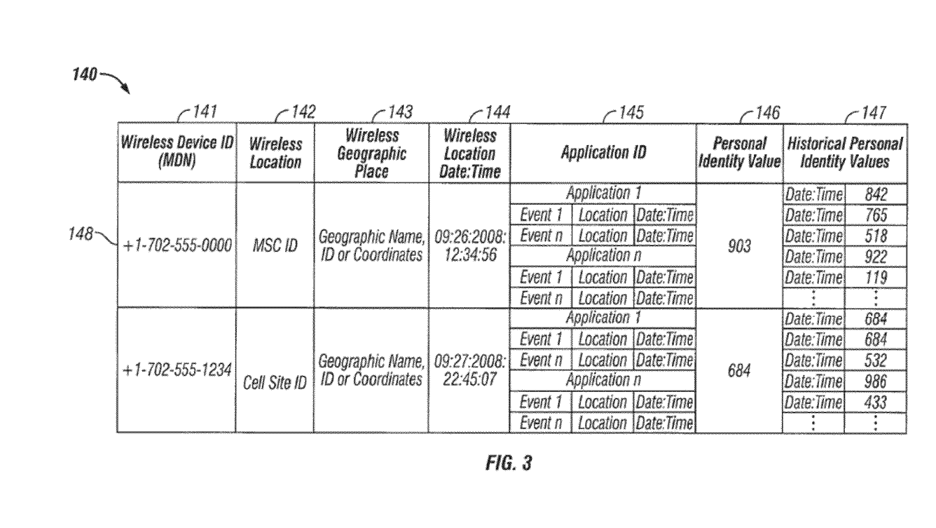

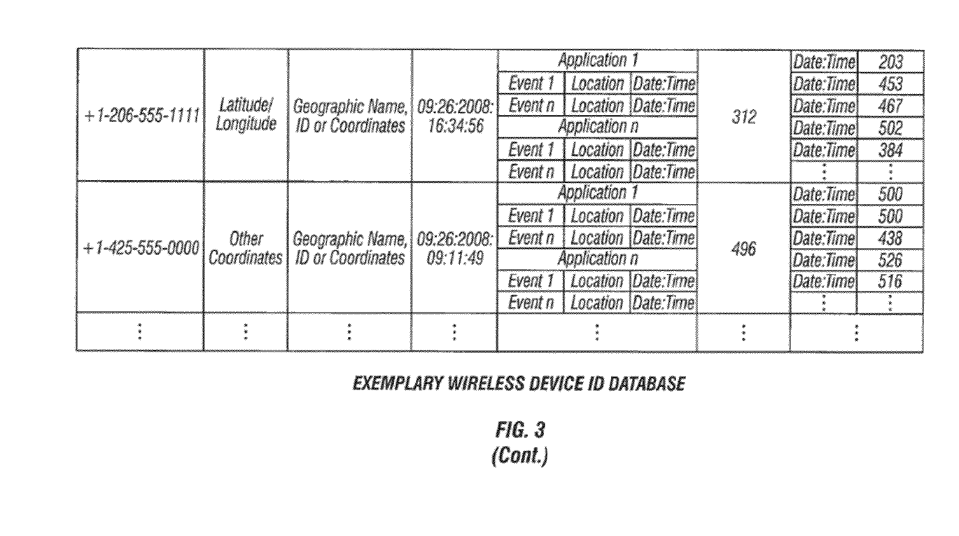

FIG. 3 depicts exemplary entries in an exemplary Wireless Device ID Database 140 shown in FIGS. 1 and 2. In particular, as depicted in FIG. 3, a first entry 148 includes an association among a Wireless Device ID 141 (e.g. in this case an MDN), the Wireless Location 142, the Wireless Geographic Place 143 associated with the Wireless Location 142, the Wireless Location Date and Time 144 associated with the Wireless Location 142, the Application ID 145 representing the relevant identity authentication application, the fraud risk score 146 and Historical fraud risk scores 147. The Wireless Device ID is used by the Wireless Device Location Module 110 in FIGS. 1 and 2 to either request the Wireless Location 142 from the Wireless Network 200 in FIG. 1 or autonomously receive the Wireless Location 142 from the Wireless Network 200. The obtained Wireless Location 142 is then associated with a Wireless Geographic Place 143 as well as the Wireless Location Date and Time 144 in the database. The entries for Wireless Geographic Place 143 in the database may be pre-populated and resolved for the obtained Wireless Location 142 or otherwise derived based upon known mapping information within the database. Examples of the Wireless Location 142 value obtained via the Wireless Device Location Module 110 in FIGS. 1 and 2 may be Mobile Switching Center (MSC) ID, Cell Site ID, latitude or longitude coordinates or any other projection coordinates that may be associated with a Wireless Geographic Place 143. Examples of the Wireless Geographic Place 143 entries in the database are a Geographic Name, some Geographic Identifier (ID) value that facilitates one or more subsequent Identity Risk Logic Resources 130 in FIGS. 1 and 2 or Coordinates that may take on the form of latitude and longitude or any other projection coordinates that may facilitate one or more subsequent Identity Risk Logic Resources 130 in FIGS. 1 and 2. Examples of the Wireless Location Date and Time 144 entries in the database are also provided. The Wireless Location Date and Time 144 entries may, for example, represent a previously known date and time of a particular obtained wireless device location to assist in determining, for example, a fraud risk score 146.

The Application ID 145 contains entries in the database that associate a particular Application (e.g. Application 1, Application 2, etc.) received along with Event Data 310 in FIGS. 1 and 2, the Event type associated with the Event Data 310 in FIGS. 1 and 2, the Location associated with the Event Data 310 in FIGS. 1 and 2 and the Date and Time associated with the Event Data 310 in FIGS. 1 and 2. The fraud risk score 146 for the associated Wireless Device ID 141 has been generated due to some previous Identity Authentication Event 330 in FIGS. 1 and 2 and based upon some previously received Event Data 310 in FIGS. 1 and 2 or Identity Data 320 in FIGS. 1 and 2. Both the fraud risk score 146 and Historical fraud risk scores 147 may be used in one or more Identity Risk Logic Resources 130 in FIGS. 1 and 2 to generate subsequent fraud risk scores that may be stored in the exemplary Wireless Device ID Database 140.

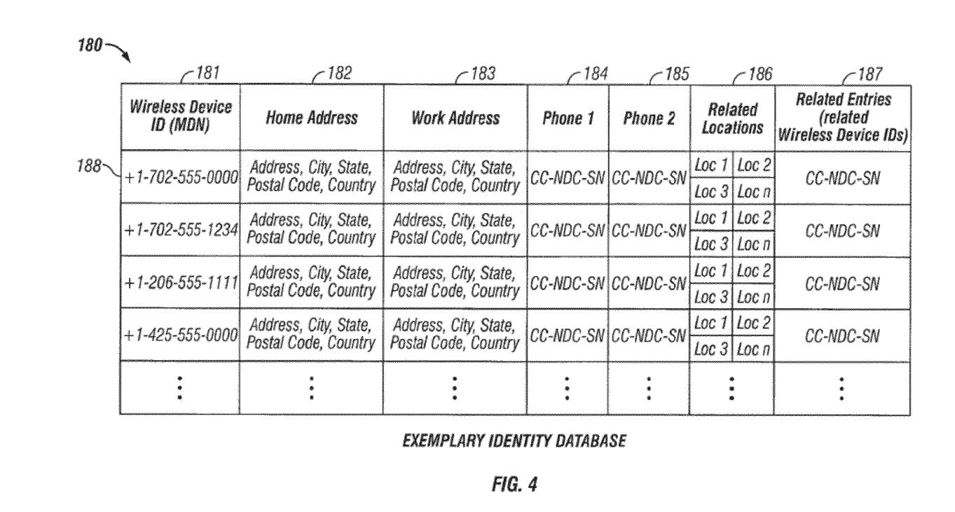

FIG. 4 depicts exemplary entries in an exemplary Identity Database 180 shown in FIGS. 1 and 2. In particular, as depicted in FIG. 4, a first entry 188 includes an association among a Wireless Device ID 181 (e.g. in this case an MDN), the individual's Home Address 182, the individual's Work Address 183, one of the individual's phone numbers, Phone 1 184, a second of the individual's phone numbers, Phone 2 185, other or additional Related Locations 186 and Related Wireless Device ID Entries 187. The Wireless Device ID is used by the exemplary Wireless Device ID Database 140 in FIGS. 1 and 2 and FIG. 3, and the Wireless Device Location Module 110 in FIGS. 1 and 2. The Wireless Device ID may be used as the primary parameter used to associate data from the Wireless Device ID Database 140 in FIGS. 1 and 2 and FIG. 3, the present Identity Database 180 in FIGS. 1 and 2, Event Data 310 in FIGS. 1 and 2 and Identity Data 320 in FIGS. 1 and 2 to provide aggregate data and appropriate parameters to be used in one or more Identity Risk Logic Resources 130 in FIGS. 1 and 2. The entries for the individual's Home Address 182, the individual's Work Address 183, one of the individual's phone numbers, Phone 1 184, a second of the individual's phone numbers, Phone 2 185, other or additional Related Locations 186 and Related Wireless Device ID Entries 187 may be provided directly by an individual via an Online Registration application 350 in FIG. 2 or indirectly as provided along with Event Data 310 in FIGS. 1 and 2. The Home Address 182 represents the home address of the individual and may contain detailed address data including House Number, Apartment Number, Street Name, City, State, County, District, Postal Code, Country or other relevant address data. The Work Address 183 represents the place of work of the individual and may contain detailed address data including Building Number, Suite Number, Street Name, City, State, Postal Code, Country or other relevant address data. Phone 1 184 and Phone 2 185 represent additional telephone numbers that the individual may use that may be associated with the individual's identity. These telephone numbers are geographically based and are of the format CC for Country Code plus NDC for National Destination Code plus SN for Subscriber Number. These telephone numbers may be other Mobile Directory Numbers (MDNs) or wireline telephone numbers used for home or work. Other Related Locations 186 represent other locations associated with an individual that may take on address values similar to Home Address 182 and Work Address 183 as well as telephone numbers similar to Phone 1 184 and Phone 2 185. These other locations may represent, for example, favorite locations frequented by the individual such as relatives' or friends' homes or other places commonly visited. Related Wireless Device ID Entries 187 may be provided that may be used to associate a record in the present exemplary Identity Database 180 with another record in the present exemplary Identity Database 180 identified by a Wireless Device ID 181 or to associate multiple records identified by a Wireless Device ID 141 in the exemplary Wireless Device ID Database 140 in FIGS. 1 and 2 and FIG. 3. This association may be required when, for example, multiple Wireless Device IDs or MDNs are associated among family members that may reside within the same household or otherwise share applications or accounts associated by the same Application ID 145 within an exemplary Wireless Device ID Database 140 in FIGS. 1 and 2 and FIG. 3. The data stored in the exemplary Identity Database 180 may be used along with the data stored in the exemplary Wireless Device ID Database 140 in FIGS. 1 and 2 and FIG. 3 as parameters used by one or more Identity Risk Logic Resources 130 in FIGS. 1 and 2.

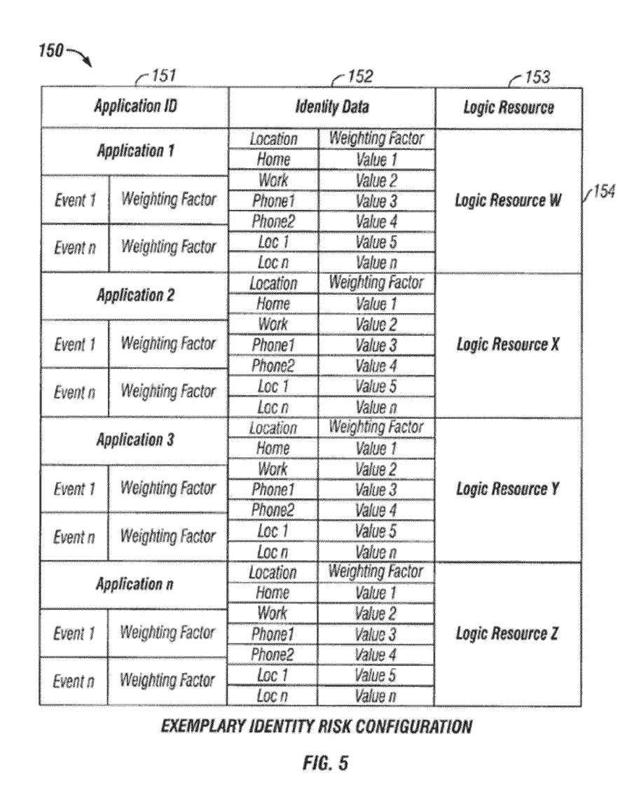

FIG. 5 depicts exemplary entries in an exemplary Identity Risk Configuration file 150 shown in FIGS. 1 and 2. This exemplary Identity Risk Configuration file is used to provide information and data to one or more Identity Risk Logic Resources 130 in FIGS. 1 and 2 that indicate the particular data parameters and factors for the data parameters used by the Identity Risk Logic Resources 130 in FIGS. 1 and 2. In particular, as depicted in FIG. 5, a first entry 154 includes an Application ID 151, Identity Data 152 and the particular Identity Risk Logic Resource 153 associated with the particular Application ID 151 and Identity Data 152. The Application ID 151 represents the same Application ID within the Wireless Device ID Database 145 in FIG. 3 and is comprised of particular Events (e.g. Event 1, Event n, etc.) and Weighting Factors for those Events associated with a particular Application (e.g. Application 1, Application 2, etc.). These Events (e.g. Event 1, Event n, etc.) are events associated with Event Data 310 in FIGS. 1 and 2 associated with an Identity Authentication Event 330 in FIGS. 1 and 2, associated with some identity authentication application. The Weighting Factors are used to provide a relative value of the importance of the particular Event (e.g. Event 1, Event n, etc.) for the particular Application (e.g. Application 1, Application 2, etc.) used by one or more Identity Risk Logic Resources 130 in FIGS. 1 and 2. The values of these Weighting Factors may be changed automatically based upon the distance and time variances among any of the location and time parameters used enabling the Identity Risk Logic Resources 130 in FIGS. 1 and 2 to provide accurate fraud risk scores indicating a likelihood of identity theft for the particular application represented by the Application ID 151 and Application ID 145 in FIG. 3. The Identity Data 152 is comprised of particular Locations (e.g. Home, Work, Phone 1, Phone 2, Location 1, Location n, etc.) and Weighting Factors for those Locations associated with a particular Application (e.g. Application 1, Application 2, etc.) and the provided Identity Data within the exemplary Identity Database 180. The Weighting Factors are used to provide a relative value of the importance of the particular Location for the particular Application (e.g. Application 1, Application 2, etc.) used by one or more Identity Risk Logic Resources 130 in FIGS. 1 and 2. The values of these Weighting Factors may be changed automatically based upon the distance and time variances among any of the location and time parameters used enabling the Identity Risk Logic Resources 130 in FIGS. 1 and 2 to provide accurate fraud risk scores indicating a likelihood of identity theft for the particular application represented by the Application ID 151 and Application ID 145 in FIG. 3.

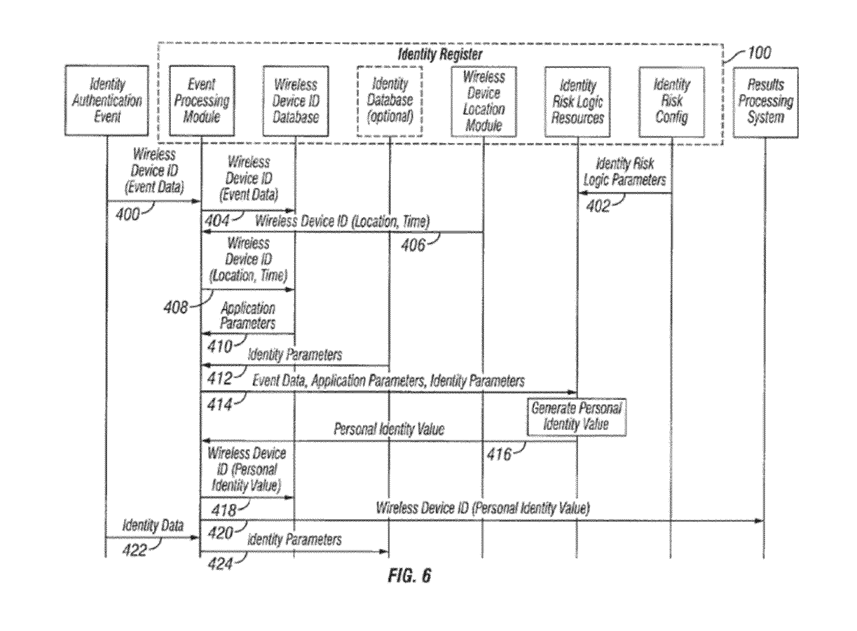

FIG. 6 is an exemplary detailed information and system flow diagram representing the operation of an Identity Register, in accordance with one embodiment of the present invention. In this exemplary information and system flow, an entity or individual may initially invoke manually or automatically some transaction or application-based activity associated with an identity authentication application resulting in an Identity Authentication Event 330 in FIGS. 1 and 2.

Step 400: An Identity Authentication Event occurs and a Wireless Device ID and associated Event Data is sent to the Event Processing Module of the Identity Register. The Wireless Device ID and associated Event Data may be sent autonomously or requested based on some other interaction between the Identity Register and the identity authentication application.

Step 402: Identity Risk Logic Parameters are either requested from the Identity Risk Configuration or sent to the appropriate Identity Risk Logic Resource. This step may occur at any time and is not necessarily dependent on any actions occurring external to the Identity Register.

Step 404: The Event Processing Module passes the Wireless Device ID and associated Event Data to the Wireless Device ID Database for storage and subsequent use by the appropriate Identity Risk Logic Resource associated with the particular identity authentication application.

Step 406: The Wireless Device Location Module passes the Wireless Device ID along with the associated Wireless Location and Time either directly to the Wireless Device ID Database or indirectly via the Event Processing Module. The Wireless Location may have been initially requested by the Wireless Device Location Module via the Event Processing Module or autonomously sent to the Wireless Device Location Module.

Step 408: If the Wireless Location and Time associated with the Wireless Device ID is passed to the Event Processing Module, it is then passed to the Wireless Device ID Database.

Step 410: The appropriate data and parameters stored within the Wireless Device ID Database and required by the Identity Risk Logic Resources are passed either directly to the Identity Risk Logic Resources or indirectly to the Identity Risk Logic Resources via the Event Processing Module.

Step 412: The appropriate data and parameters stored within the Identity Database and required by the Identity Risk Logic Resources are passed either directly to the Identity Risk Logic Resources or indirectly to the Identity Risk Logic Resources via the Event Processing Module.

Step 414: If the appropriate data and parameters have been passed to the Event Processing Module from the Wireless Device ID Database or the Identity Database, they are subsequently passed to the appropriate Identity Risk Logic Resource to be used in a calculation to generate a fraud risk score for the particular Event and identity authentication application.

Step 416: A fraud risk score is generated and passed either directly to the Wireless Device ID Database or indirectly to the Wireless Device ID Database via the Event Processing Module.

Step 418: If the fraud risk score is passed to the Event Processing Module, it is then passed to the Wireless Device ID Database for storage and to be used by one or more identity authentication applications.

Step 420: The fraud risk score is passed to a Results Processing System that may be associated with an identity authentication application to effect some utility in the concerned automated application, activity or transaction engaged in by the entity or individual identified by the Wireless Device ID.

Step 422: An Identity Authentication Event occurs and a Wireless Device ID and associated Identity Data is sent to the Event Processing Module of the Identity Register. The Wireless Device ID and associated Identity Data may be sent autonomously or requested based on some other interaction between the Identity Register and the identity authentication application. This step may be specific to an online registration event by an entity or individual registering with the Identity Register and may occur at any time separate and distinct from Steps 400 through 420.

Step 424: Identity Parameters associated with the Wireless Device ID and associated with an online registration event by an individual registering with the Identity Register are sent to the Identity Database for storage and subsequent use in generating a fraud risk score.

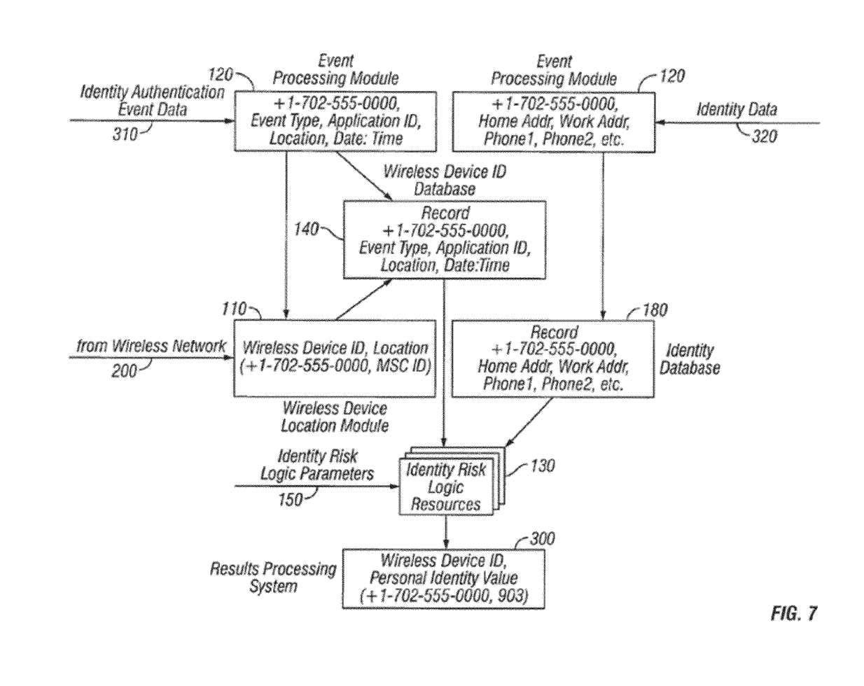

FIG. 7 is an exemplary detailed process flow diagram representing the operation of an Identity Register, in accordance with one embodiment of the present invention. In this exemplary process flow, an entity or individual may initially invoke some transaction or application-based activity resulting in an Identity Authentication Event 330 in FIGS. 1 and 2. In this exemplary process flow, the Identity Authentication Event Data 310 are provided to the Event Processing Module 120. The Event Data consists of a value of “+1-702-555-0000” as an exemplary Wireless Device ID and, more specifically, the MDN of an entity or individual whose identity requires authentication. The Event Data also consists of an Event Type, which may be an authentication event, an Application ID pertaining to the particular application requiring identity authentication for the entity or individual and the Location and Date and Time of the authentication event. Identity Data 320 are provided to the Event Processing Module 120. The Identity Data consists of a value of “+1-702-555-0000” as an exemplary Wireless Device ID and, more specifically, the MDN of an entity or individual whose identity requires authentication. The Identity Data also consists of the Home Address, Work Address, Phone 1 and Phone 2 and potentially other related location data.

The Event Processing Module 120 passes the Identity Authentication Event Data 310 to the Wireless Device ID Database 140. The Wireless Device ID Database 140 records and stores the Identity Event Authentication Data 310.

The Event Processing Module 120 passes the Identity Data 320 to the Identity Database 180. The Identity Database 180 records and stores the Identity Data 320.

In this exemplary process flow, the Wireless Device ID and Wireless Location are provided to the Wireless Device Location Module 110 by the Wireless Network 200. An exemplary value for the Wireless Device ID may be “+1-702-555-0000” which serves as the MDN of the entity or individual. An exemplary value for Wireless Location may be “MSC ID” which serves as a physical and geographically-based area that may be currently serving the Wireless Device represented by the MDN. The Wireless Device ID and associated Wireless Location are passed from the Wireless Device Location Module 110 to the Wireless Device ID Database 140.

The Wireless Device ID Database 140 and the Identity Database 180 pass all relevant data parameters associated with the Wireless Device ID represented by the exemplary value “+1-702-555-0000” to one or more Identity Risk Logic Resources 130.

Identity Risk Logic Parameters 150 are passed to the Identity Risk Logic Resources 130 for use in generating a fraud risk score for the entity or individual represented by the exemplary value “+1-702-555-0000” and the appropriate Application ID from the Identity Authentication Event Data 310.

One or more Identity Risk Logic Resources 130 are used to calculate and generate a fraud risk score for the particular authentication application for the entity or individual represented by the unique Wireless Device ID represented by the exemplary value “+1-702-555-0000.”

The generated fraud risk score represented by the exemplary value “903” and the unique Wireless Device ID represented by the exemplary value “+1-702-555-0000” for the entity or individual are sent from the Identity Risk Logic Resources 130 to a Results Processing System 300. The Results Processing System 300 may then apply the fraud risk score to, for example, an authentication, verification or validation application used to authenticate, validate or verify the entity's or individual's identity who is engaged in some automated secure activity or transaction.

In accordance with an embodiment of the present invention, an Identity Register is provided. The Identity Register comprises modules that obtain wireless device location from a Wireless Network as well as Event Data associated with an identity authentication application and Identity Data pertaining to an entity or individual. One or more Identity Risk Logic Resources are employed to generate fraud risk scores for entities or individuals engaged in a secure and automated activity or transaction representing the likelihood that identity theft has occurred or is occurring. The secure activity or transaction may be a commercial point-of-sale transaction at a retail establishment, an online banking transaction from a personal computer, an e-commerce transaction from a personal computer, a computer-automated voting application, an automated alarm system or the invocation of any automated application where a likelihood of identity theft may occur. The fraud risk scores may be provided in a multiplicity of formats and sent to a Results Processing System where they may be applied to a particular application.

The present invention provides multiple benefits. The use of an Identity Register and generated fraud risk scores may significantly reduce incidents of financial identity theft and identity deception. The present invention provides identity authentication for any type of secure and automated activity or transaction and may reduce the incidence of false positive indications of fraudulent activity using only traditional fraud detection mechanisms in use today. Additionally, use of fraud risk scores as described in the present invention adds utility to a multiplicity of computer applications, networks and devices requiring secure user access or authentication.

An embodiment includes a mobile wallet/payment security approach to address an area of concern in the wireless industry associated with mobile wallet/payment offerings.

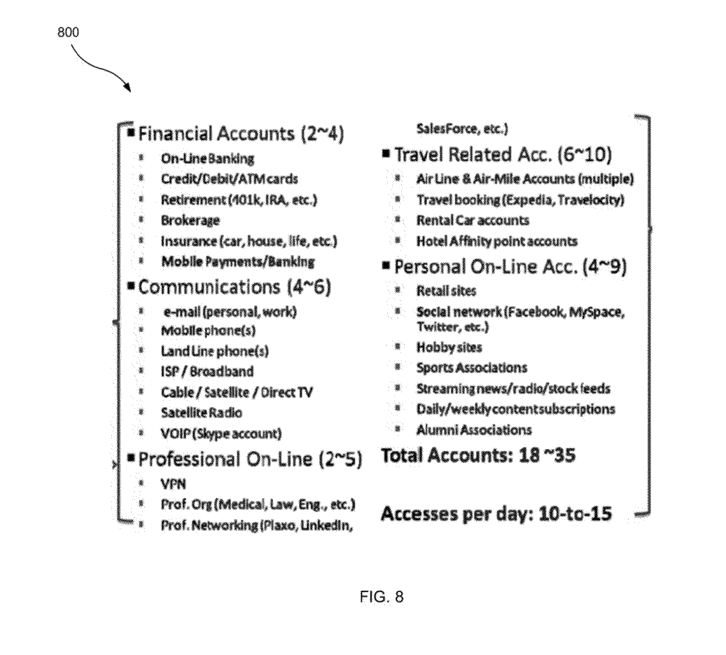

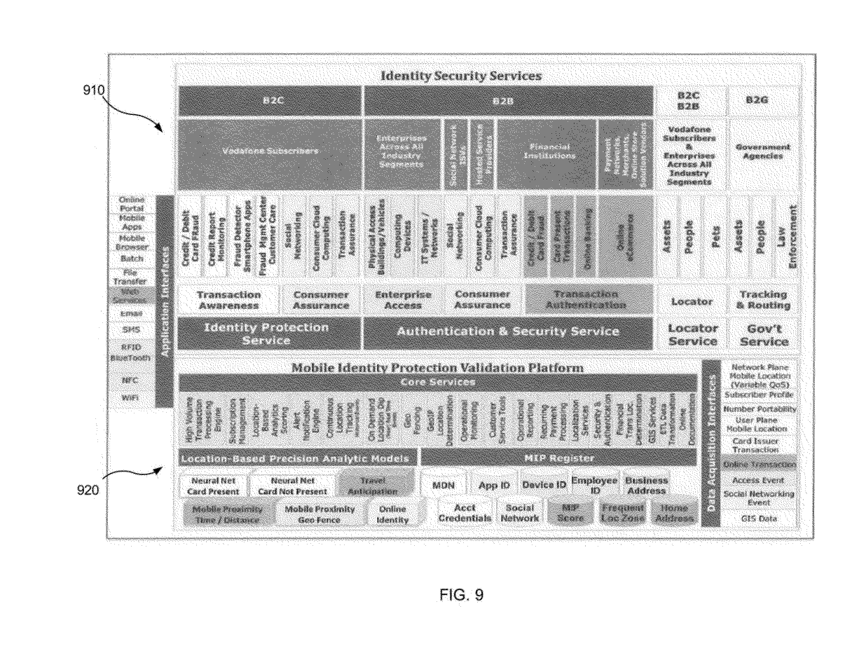

Referring back to FIG. 1, in an embodiment, Data 310 may be associated with exemplary Events 330 associated with events/accounts 800 illustrated in FIG. 8. Referring to FIG. 9, illustrated are components of ISS 910 and a mobile identity protection validation platform 920. The illustrated components of ISS 910 and platform 920 may be implemented by, include, or be included by, the components 110-180 of which identity register 100 is comprised.

Through relationships with wireless carriers, an administrator implementing an embodiment has access to wireless subscriber data (e.g., Data 320) including geo-location, billing, and other customer information, both real-time and historical. Alternatively, the subscriber data may be obtained from mobile device itself This could be through a stand-alone mobile application that the user has downloaded to the mobile device specifically for such a purpose or through other applications that have permission to use the data and pass on to the administrator. Through the use of this wireless data and data from a multitude of sources (see FIG. 8), an embodiment includes a Location-based Analytics Statistically Engineered Response analytics engine to analyze, preferably continuously, the data and produce a fraud risk score that can be used by any vendor providing services to the customer to authenticate the customer, and/or the customer's event transaction, in its fraud validation systems, elements of which are illustrated in FIGS. 1 and 9. A benefit of an embodiment of the invention is its ability to continuously update the fraud risk score based on changing inputs, and thus be capable of providing real-time and/or near real-time authentication scores for alerting, allowing, and/or denying customer events, including access events, financial transactions, including mobile wallet, payments, withdrawals, or transfers.

Because of the access to wireless subscriber data, this embodiment of the invention has the ability to authenticate the actual mobile device and incorporate this authentication into the actual risk score. Thus, the compromising of the mobile phone itself through theft, fraud, or electronic means becomes part of the fraud risk score of this embodiment of the invention. The fraud risk score of this embodiment of the invention can be used in transactions that rely on the identity of the mobile phone's owner, such as mobile wallet transactions, to indicate whether the mobile phone itself has been compromised. And, because this embodiment of the invention accepts a multitude of data inputs, such as from financial institutions, this embodiment of the invention authenticates the mobile device and the mobile payment system on the device providing a much more accurate, real-time fraud risk score to either validate or deny a transaction being made by the subscriber of the mobile wallet device.

The dynamic nature of the fraud risk score allows additional data inputs to continuously update the fraud risk score such that if the fraud risk score attains a certain level, the mobile wallet/payment application capability is denied on the mobile phone until either the fraud risk level reaches an acceptable fraud risk level, or a second factor of authentication is provided or obtained by the service provider to proceed with the transaction event, such as a mobile wallet and payment capability.

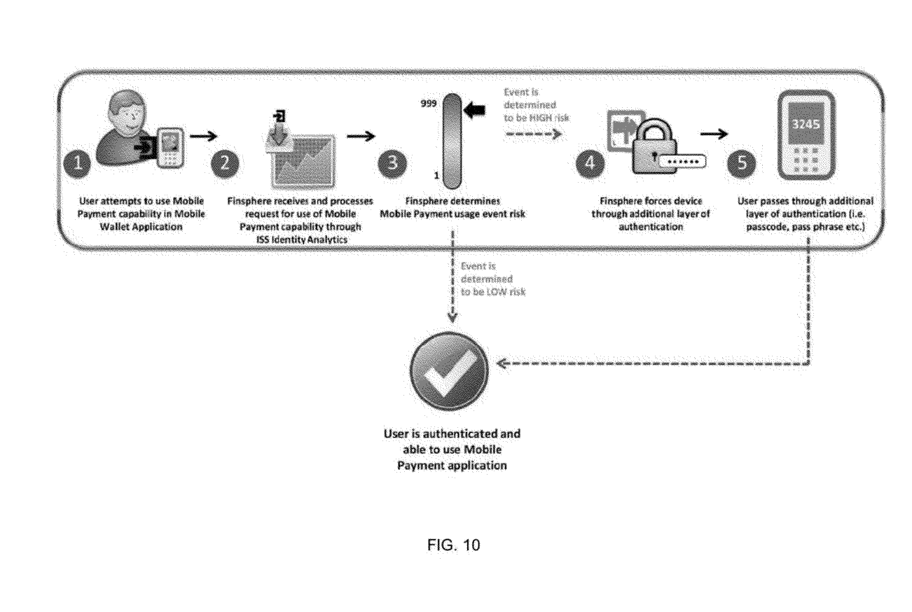

Creating digitized secure mobile application versions of membership cards, affinity cards, travel cards, transport tickets, identity cards, etc. is one of the strategies of mobile wallet initiatives. An embodiment allows a user access to this digitized information on the mobile application, preferably only when the fraud risk score is at or below a certain level; or when a second factor of authentication is provided. Thus the mobile phone itself utilizes the fraud risk score to either allow access or deny access to mobile phone apps, enhancing a mobile phone user's privacy and security (see FIG. 10).

An embodiment continuously collects and correlates mobile data from a wide variety of sources, such as those illustrated in FIG. 8, to output a fraud risk score to service providers or a user mobile device. In an embodiment, mobile subscriber data could be data from the mobile device itself or any application on the mobile device, including a digital or mobile wallet.

An embodiment provides mobile payment/banking transaction security and authentication: for example, the mobile application may be functional only when ISS analytics-based fraud risk score is low enough, or when an additional authentication factor is provided.

An embodiment provides digitized wallet content access security and authentication: for example, the mobile application may be functional only when ISS analytics-based fraud risk score is low enough, or when an additional authentication factor is provided.

An embodiment provides ISS mobile analytics fraud risk scoring technology.

Referring to FIG. 9, the MIP Validation Platform 920 is responsible for all core services shared by the externally exposed ISS 910 application services. In support of the shared service model, the platform is architected for multiple event types, including, but not limited to the following:
A. Transaction-based events (e.g. financial transactions)
B. Online access events (e.g. VPN, website logins)
C. Physical access events (e.g. building access)

Components of the MIP Validation Platform are:
A. MIP Validation Platform Core Services
B. MIP Register
C. Location-Based Precision Analytic Models

MIP Validation Platform core services are a set of high-performance services exposed to ISS application services through a set of documented APIs.

MIP Validation Platform core functions and services include, but are not limited to:
A. High volume transaction processing engine, supporting real-time streaming, near real-time streaming, and batch data feeds.
B. Subscription Management, including management of user consent (confirmed opt-in, opt-out) and user preferences
C. Location-based precision analytics scoring (generation of fraud risk score) for both named and anonymous users
D. Alert notification engine, including SMS text messaging and email
E. Continuous location tracking for scoring of historical events
F. On demand location dips for scoring of (near) real-time event
G. Geo fencing, which when crossed, can trigger a warning to the user or operator via SMS or email
H. Financial transaction location determination, including support for both structured (e.g. ISO 8583 financial transaction card originated interchange message) and unstructured (e.g. financial aggregator) financial transaction message protocols
I. GeoIP location determination
J. Operational monitoring services, implemented using standard protocols for use with industry standard network and systems management platforms
K. Operational administration services
L. Customer Service tools for Tier 1 and Tier 2 support
M. Operational reporting services
N. Recurring payment processing services, including tax calculation and reporting services, for billing recurring subscript ions in the event that Bill on Behalf Of (BoBo) services are not available through the licensed partner platform
O. Internationalization services, including locale support (e.g. date, time, currency) and localization services.

Security and authentication services to protect the confidentiality, integrity and availability of data received, transmitted or stored by the MIP Validation Platform
A. Geographic Information System (GIS) services, such as generation and use of shape data for storing geometric location and associated attribute information
B. Data Transformation services to accommodate clients who submit events for scoring in a format other than t he standard ISS service message format
C. Internal application programming interfaces (APIs) used by ISS services
D. Data acquisition APIs for acquiring data input into the precision analytic models, such as wireless network plane data, wireless user plane data, mobile number portability data, mobile subscriber data and geographic information systems (GIS) data.
E. Data persistence services, including support for both structured (e.g. relational databases, XML files) and unstructured data (e.g. HTML templates for customer communications)
F. Data caching services, to maximize performance and scalability
G. Online Documentation

The Mobile Identity Protection Register, also known as the MIP Register, is the database of record for uniquely identifying subscribers. When a user opts into one or more ISS services, a user profile is created in the MIP Register.

In an embodiment, subscribers may be auto-provisioned in the MIP Register and thus may proceed directly to account activation without having to explicitly sign up for the ISS service.

The profile contains user information such as:
A. Mobile Number (MSISDN/MDN), which uniquely identifies a user
B. Subscriber Indicative Data
   1. Subscriber name
   2. Age
   3. Gender
   4. Email address
   5. Home address
   6. Home address type (customer provided or derived for prepaid subscribers)
   7. Indicative data change events (change in home address)
C. Subscriber Service Data
   1. Mobile handset device type
   2. Names of all other individuals on th e account
   3. Landline service location information
   4. Service start date
   5. Service termination date
   6. Service plan information (e.g. family plan, voice minutes)

Subscriber features information (e.g. call forwarding)
1. Billing type (prepaid or post-paid)
2. Billing address
3. Billing history
4. TopUp history for prepaid subscribers
5. Current credit rating
6. Credit history
7. Number portability information
B. ISS Service Subscription State (confirmed opt-in, confirmed out-out, subscription request pending confirmation)
C. MIP Scores, which describes the current fraud risk for a user or user account. If a user is subscribed to more than one ISS services, increased risk for one ISS managed account (e.g. social network account) may impact the perceived risk of another ISS managed account.
D. External User IDs, which uniquely identify a user in external systems (e.g. Facebook Username, Company Employee 10, etc. . . . )
E. Non-unique information which may be used to further authenticate the user, such as a verified IP address used to access an online accounts or frequent location zone

By correlating user information across multiple ISS services into a single user profile, the MIP Register plays a key role in authenticating a user across the broad spectrum of access events that they participate in on any given day.

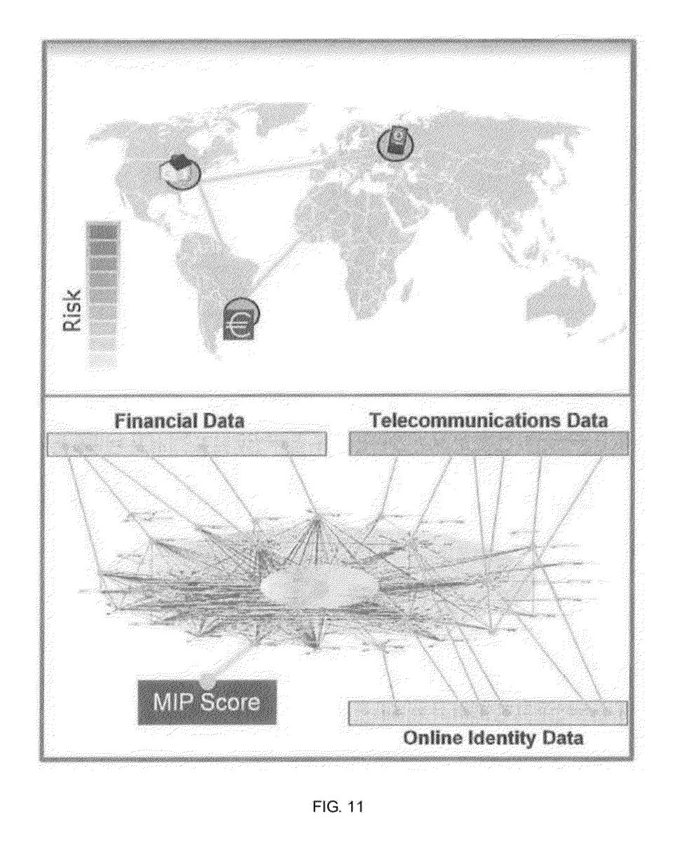

Referring to FIG. 11, included in the ISS Solution is a set of location-based precision analytic models, which combine the power of predictive analytics with ‘current state’ information from multiple, independent data sources (e.g., financial, telecommunications, online identity) to score an event. These independent data sources are mutually exclusive to those used in the dominant fraud mitigation and user authentication solutions on the market today.

Telecommunications data useful in predictive analytics extends well beyond mobile location data and data stored in the MIP Register to include:
A. Subscriber Demographic Data (owner profile derived from mobile device type, e.g. iPhone owners have certain characteristics)
B. Subscriber Behavioral Data (internet browsing history, e.g. websites visited, search terms used)
C. Call Detail Record Data (calling patterns between groups of users, calling party number, called party number, call start date/time, call duration, call type (voice, SMS)

ISS analytic models include both expert rule-based models as well as neural network models. A key input into these MIP scoring algorithms is physical positioning data, which may take many forms, including latitude and longitude coordinates and location contexts such as street addresses, postal codes, districts, cities, counties and councils, landmarks and countries. The algorithms enable the comparative analysis of mobile location data with other location data, such as evaluating the distances between position coordinates or between location contexts, attenuating for maximum potential movement since the event occurred. Some models are built to anticipate future travel rather than simply scoring events during or after they occur.

Note that a simple comparison between a mobile device location and the limited information attached to a single physical or logical event being authenticated is insufficient to properly assess fraud risk. Precision analytics is required because data attached to a single event is imperfect, either missing, invalid or misleading. Precision analytics is also required because the quality of mobile location available for a particular event may be poor.

Consider the following situations:
A. A merchant's payment processing system is configured to pass the location of its corporate headquarters rather than the specific retail location where transactions occur, thus invalidating a score based solely on the proximity between a mobile device and the transaction location.
B. A cardholder leaves their phone at home when traveling. Thus, the mobile location is no longer representative of where the cardholder is when a legitimate credit card transaction occurs.
C. A cardholder travels on business outside a network where knowledge of mobile location may be limited to simply the country in which the user's mobile device is located.

While still valuable in assessing risk, precision analytics will weight this coarse mobile location information less than granular location information such as cell site latitude/longitude coordinates. If the user's credit card is then compromised in the country they are visiting, a simple comparison of whether the mobile phone is located in the same country as a transaction may be insufficient to detect an aberrant event.
A. A user logs into their online account from a remote location where the confidence in the geoIP address location is less than 70%, thus significantly decreasing the relevancy of assessing fraud risk solely on the proximity of the mobile device to the geoIP address.

The ISS Solution accommodates these types of anomalies. ISS precision analytics neural net models evaluate tens and sometimes hundreds of variables in assessing the risk of any single event and thus can properly calibrate fraud risk even when the event data and/or mobile location data is imperfect.

ISS 910 may be hosted applications built on top of the MIP Validation Platform 920. ISS 910 services may include both consumer and enterprise applications, with some services targeted at both. Included application suites, as illustrated in FIG. 9 and categorized by target market, are:
A. Identity Protection Service (B2C services) and
B. Authentication and Security Services (B2B services)

In an embodiment, the Identity Register 100 can support M2M (machine to machine) technology and applications. Below are several areas where such can apply, including examples:

Machines interact in certain ways based on the Identity Register's 100 fraud risk score. The used fraud risk score triggers a computing device to perform a certain function with another computing device.

Examples:
(A) An individual in his car wishes to enter a garage. The individual requests access to a garage via any of a number of means (e.g., touches app on smartphone; punches button on garage door opener device; touches key card to key card receiver outside of garage; etc.). Garage door opening computing system obtains fraud risk score of entity requesting access into the garage from the Identity Register computing system. The garage door opening system allows or denies access of car based on the fraud risk score it receives from the Identity Register.
(B) A parent wishes to control a child's access to certain TV channels when the parent is present at the house where the TV is. When the TV channel is selected and requested, the TV system obtains the fraud risk score of the parent and upon a certain fraud risk score level the TV channel is accessed. The same could apply to certain web sites on the Internet from a web browser on a TV or computer.
(C) An enterprise supervisor wishes to control access to certain physical rooms or computing storage locations to only when supervisor is physically present at the enterprise location. The same process as “b.” above applies.

A machine operates in a certain way based on the operator of the machine's fraud risk score. The operator's machine may a perform only a certain operation with another machine; or b. perform multiple functions with other machines.

Examples:
(A) A pharmacy is sent a critical package of medications and an electronic device is used to receive shipment and put the medications in inventory. To control the security of the medications, only certain individuals employed by the pharmacy may use the electronic device to receive the shipment. For the electronic device to work properly, at least one of the proper employees' fraud risk scores must be at a certain level.
(B) A worker at an enterprise wishes to operate a very sensitive machine where only specially trained workers can safely operate it. As the worker attempts to turn on the machine, the machine obtains a fraud risk score from the Identity Register system and upon the fraud risk score being at a certain level the machine becomes operable by the worker.

In an embodiment, all of the captured data has, in and of itself, tremendous value from a marketing/advertising perspective. As such, the output could be the fraud risk score or the raw or manipulated data.

In an embodiment, the Identity Register 100 is able to analyze disparate authentication events of a consumer of where, how, when, and what merchant, and then offer up data to advertisers for various offers (e.g., plastic card present transaction at Sammamish Safeway at 7 am; Starbucks Square digital wallet transaction at Bellevue at 7:30 am; plastic card present purchase at Flying Bagels at 7:45 am; access of office building in Bellevue at 8:00 am; login to Barnes and Nobel site and buy a book through online mobile wallet account at 8:30 am; buy a cup of coffee at different Starbucks in Bellevue using Square automatic digital wallet payment service; etc.). The Identity Register 100 learns a user's authentication patterns and analyzes his/her digital life events. Not only can all of this data be used to protect his/her identity and not unnecessarily decline his/her transaction when the user travels (e.g., user doing a transaction at a Starbucks in the morning in Washington DC is probably consistent with behavior in mornings in Seattle), but it can also create advertising opportunities for merchants that want to reward user transaction behavior (e.g., Starbucks sending the app on user's phone a free latte reward at 7 am some morning), and an opportunity for another merchant to offer the user something (e.g., Noah's bagels offering a free cup of coffee with any bagel purchase at 7 am). In such an embodiment, the advertised offers could appear within the digital wallet smartphone app and not a text message.

Traditional approaches only use geo-location of mobile devices to try and figure out what promotions and when to send promotions to customers. This embodiment includes the geo-location of the mobile device as just one piece of information.

Indeed, an embodiment includes the ability to implement location as a cardholder verification methodology for transaction authentication/authorization. Such an embodiment may include the embedding of information on a memory device, such as, for example, a chip card, separate and apart from the user's mobile telephone, as well as a mobile application configured to run on the user's mobile telephone and/or in conjunction with a mobile network operator.

For example, in an embodiment, the cardholder's mobile telephone number can be embedded (i.e., stored) on the chip portion of the chip card. The chip portion may include an integrated circuit, for example. Subsequently, in response to an attempt by the cardholder to execute a financial transaction using the chip card on which the mobile phone number is embedded, the mobile phone number may be automatically provided over a network to an authentication server configured to determine whether the location of the mobile phone associated with the embedded mobile phone number is within a predetermined distance of the location of the point of sale terminal with which the financial transaction is attempted. If the location of the mobile phone associated with the embedded mobile phone number is within the predetermined distance of the terminal, the authentication server can then provide an authorization signal to the terminal, thereby allowing the attempted financial transaction to be completed.

While the preferred embodiment of the preferred embodiment of its invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

What is claimed is:

1. A method, comprising the steps of:
detecting a user attempt to perform an activity using an apparatus in cooperation with an electronic device, the apparatus including a memory device on which a mobile phone number is stored;
automatically receiving over a network the mobile phone number and an indicator of the location of the electronic device;
determining whether the location of a mobile phone associated with the stored mobile phone number is within a predetermined distance of the location of the electronic device; and
if the location of the mobile phone associated with the stored mobile phone number is within the predetermined distance of the electronic device, providing to the electronic device an authorization signal enabling the attempted activity to be completed.

2. The method of claim 1, wherein the memory device comprises a credit card.

3. The method of claim 2, wherein the memory device comprises an integrated circuit affixed to the credit card.

4. The method of claim 1, wherein the activity comprises the purchase of an item.

5. The method of claim 1, wherein the electronic device comprises a point-of-sale terminal.

6. An activity-authorization system, comprising:
a processing device, configured to:
detect a user attempt to perform an activity using an apparatus in cooperation with an electronic device, the apparatus including a memory device on which a mobile phone number is stored,
automatically receive over a network the mobile phone number and an indicator of the location of the electronic device; and
a computer-readable medium on which are stored instructions that, when executed by a processor of a mobile phone associated with the mobile phone number, enable the mobile phone to provide to the processing device the location of the mobile phone, wherein the processing device is further configured to determine whether the location of the mobile phone is within a predetermined distance of the location of the electronic device, and, if the location of the mobile phone is within the predetermined distance of the electronic device, provide to the electronic device an authorization signal enabling the attempted activity to be completed.
